(19) United States
(12) Patent Application Publication
(10) Pub. No.: US 2024/0399376 A1
(43) Pub. Date: Dec. 5, 2024

(54) Sample Collection Card for Untargeted Metabolomics and Methods of Use Thereof

(71) Applicants: University of Connecticut, Farmington, CT (US); Arome Science Inc., Farmington, CT (US)

(72) Inventors: Alexander Aksenov, Tolland, CT (US); Alexey Melnik, Tolland, CT (US); Silverio Iacono, Woodbury, CT (US)

(73) Assignees: University of Connecticut, Farmington, CT (US); Arome Science, Inc., Farmington, CT (US)

(21) Appl. No.: 18/734,104

(22) Filed: Jun. 5, 2024

Related U.S. Application Data
(60) Provisional application No. 63/506,226, filed on Jun. 5, 2023.

(51) Int. Cl. B01L 3/00

(52) U.S. Cl. CPC B01L 3/508; B01L 2300/0816; B01L 2300/0861; B01L 2300/165

(57) ABSTRACT

A liquid sample collection system is provided. The system includes a housing having a first layer and a second layer coupled to the first layer, one or more channels integrated into the first layer from a central region of the first layer to an edge of the first layer, and a card secured between the first layer and the second layer. The first layer is made, at least in part, from a hydrophobic polymer and the second layer is made, at least in part, from a hydrophilic polymer, and the one or more channels distribute the liquid sample on the card.

### CROSS-REFERENCE TO RELATED APPLICATION

This application claims the benefit of U.S. Provisional Application No. 63/506,226, filed on Jun. 5, 2023, the content of which is hereby incorporated by reference in its entirety.

### BACKGROUND OF THE INVENTION

### 1. Field of the Invention

The invention disclosed herein relates to metabolomics and, in particular to a device and system for obtaining liquid samples for use with mass spectrometry systems, including for urinalysis.

### 2. Description of the Related Art

Many chronic and acute health conditions have common symptoms such as pain, malaise, or gastrointestinal manifestations and are difficult to diagnose based on symptoms alone. When presented with non-specific symptoms, physicians often resort to a “try and see” approach. In recent years, there has been an increase in the understanding of many diseases at a molecular level, including knowledge of various molecules that could be linked to specific conditions such as exposure to toxins (e.g., fungal mycotoxins linked to tumorigenesis) or gut dysbiosis (e.g., inflammatory bowel disease (IBD)). Understanding the metabolites results in better understanding of the biochemistry of a patient. Thus, characterizing the metabolome of a patient can enable accurate and thoughtful diagnosis for a patient and lead to improved therapies for a variety of pathologies.

Currently, the use of metabolites and metabolomic panels for diagnosis are limited in the clinic. For example, tracking the oxidative load, hormonal conversion (pro-cancer state vs anti-cancer state), low-level inflammation, or nutritional status remain unavailable in the clinic.

In order to perform such an analysis a sample needs to be collected, transported to the appropriate facility, and analyzed. Typically, this analysis can be performed on urine or blood samples. The preparation and transport of liquid samples, which can be hazardous, is difficult often requiring special handling instructions, cold storage, or additional preservatives.

Accordingly, what are needed are devices and techniques for preparing samples for testing and for characterizing the metabolome and biochemistry of a patient.

### SUMMARY OF THE INVENTION

In one aspect, a liquid sample collection system is provided. The system includes a housing having a first layer and a second layer coupled to the first layer, one or more channels integrated into the first layer from a center of the first layer to an edge of the first layer, and a card secured between the first layer and the second layer. The first layer may be made of a hydrophobic polymer, the second layer may be made of a hydrophilic polymer, and the one or more channels function to distribute the liquid sample on the card.

In another aspect, a liquid sample preparation system is provided. The system includes a collection card. In an aspect, the collection card may include a first layer having a first slot and a second layer having a second slot, the second layer being coupled to the first layer with the second slot aligned with the first slot. The collection card may further include one or more channels integrated into the first layer from a center of the first layer to an edge of the first layer. An insert may be removably secured between the first layer and the second layer, the insert being configured to retain a predetermined amount of liquid sample. The first layer may be made of a hydrophobic polymer and the second layer may be made of a hydrophilic polymer. The one or more channels function to distribute the liquid sample across the insert. The insert may be removable through the first slot or the second slot. The system may further include a container, a desiccant, and/or a pair of forceps. The desiccant and the collection card may be stored in the container, e.g., for transport. The pair of forceps may be used to prevent contamination of the collection card by a user.

In a further aspect, a liquid sample collection system for mass spectrometry analysis is provided. The system includes a housing having a first layer and a second layer coupled to the first layer, one or more channels integrated into the first layer from an interior region of the first layer to an edge of the first layer, and a card secured between the first layer and the second layer. The first layer is made, in whole or in part, from a hydrophobic polymer and the second layer is made, in whole or in part, from a hydrophilic polymer. The one or more channels distribute the liquid sample over the card. The card is configured to retain a predetermined amount of the liquid sample and is adapted for use in a mass spectrometer for developing metabolomics data of the liquid sample.

### BRIEF DESCRIPTION OF THE DRAWINGS

The features and advantages of the invention are apparent from the following description taken in conjunction with the accompanying drawings in which:

FIG. 1 is a perspective view of a housing for retaining a sample card;

FIG. 2 is a perspective view of a first layer of the housing of FIG. 1;

FIG. 3 is a perspective view of a second layer of the housing of FIG. 1;

FIG. 4 is a process flow of sample preparation;

FIG. 5 is a perspective view of a sample card and housing and a sample loading plate;

FIGS. 6A and 6B are schematic views of a sample card;

FIG. 7 is a sample card and housing in a transport container;

FIG. 8 is a sample card and housing functioning as a sub-sampling device;

FIG. 9 is a process flow of sample collection and preparation;

FIG. 10 is a graphic depicting an example patient interface;

FIG. 11 depicts an example of process flow;

FIGS. 12A-B depict aspects of metabolites; and

FIG. 13 depicts elements of a system for implementing the teachings herein.

### DETAILED DESCRIPTION OF THE INVENTION

Disclosed herein are methods and apparatus for assessing chemicals found within a sample that may be obtained from various sources, e.g., from a patient. The techniques disclosed herein are directed to embodiments of assessing metabolites in a urine sample, although the techniques may be used with other sample regimens. In embodiments provided herein, the techniques may be used to collect sample(s) for us in various analytical tools, e.g., mass spectroscopy. Systems, devices, and methods set forth herein can be used to detect molecules in a sample in an untargeted (or “non-targeted”) analysis.

Generally, the term “metabolome” refers to the complete set of small-molecule chemicals found within a biological sample taken from a patient. In embodiments disclosed herein, the biological sample may be urine. However, the biological sample may be, for example, a cell, a cellular organelle, an organ, a tissue, a tissue extract, a biofluid or an entire organism. The small molecule chemicals found in a given metabolome may include both endogenous metabolites that are naturally produced by an organism (such as amino acids, organic acids, nucleic acids, fatty acids, amines, sugars, vitamins, co-factors, pigments, antibiotics, etc.) as well as exogenous chemicals (such as drugs, environmental contaminants, food additives, toxins and other chemicals) that are not naturally produced by a patient.

The metabolome includes both an endogenous metabolome and an exogenous metabolome. The endogenous metabolome can be further subdivided to include a “primary” and a “secondary” metabolome (particularly when referring to plant or microbial metabolomes). A primary metabolite is directly involved in normal growth, development, and reproduction. A secondary metabolite is not directly involved in those processes, but usually has important ecological function. Secondary metabolites may include substances that are foreign to the body of the patient, such as pigments, antibiotics, drugs, waste products derived from partially metabolized chemicals and the like.

Generally, mass spectrometry is an analytical tool useful for measuring the mass-to-charge ratio (m/z) of one or more molecules present in a sample. These measurements can often be used to calculate the exact molecular weight of the sample components. A mass spectrum is a type of plot of the ion signal as a function of the mass-to-charge ratio. The resulting spectra may be used to determine the elemental or isotopic signature of a sample, the masses of particles and of molecules, and to inform upon the chemical identity or structure of molecules and other chemical compounds within the sample.

In a typical mass spectrometry procedure, a sample, which may be solid, liquid, or gaseous, is ionized, for example by bombarding it with a beam of electrons. This may cause some of the molecules within the sample to break up into positively charged fragments or simply become positively charged without fragmenting. The ions (fragments) may then be separated according to their mass-to-charge ratio, for example, by accelerating them and subjecting them to an electric or magnetic field. In a mass spectrometer, ions of the same mass-to-charge ratio will undergo the same amount of deflection. The ions are detected by a mechanism capable of detecting charged particles, such as an electron multiplier. Results are typically displayed as spectra of the signal intensity of detected ions as a function of the mass-to-charge ratio. The atoms or molecules in the sample can be identified by correlating known masses (e.g., an entire molecule) to the identified masses or through a characteristic fragmentation pattern.

In mass spectroscopy, “targeted methods” generally have a greater selectivity and sensitivity than “untargeted” or “non-targeted” methods. In targeted methods, quantification of the metabolites is performed through the use of internal standards and authentic chemical standards to construct calibration curves for each of the metabolite. Non-targeted analysis (NTA) aims to identify all chemicals present in a given sample. At present, it is not possible to detect everything using NTA. However, researchers/practitioners can use NTA to identify both known and unknown components to gain insight as to the makeup of a sample. Given the vast array of chemicals that may exist within a metabolome, reliable characterization of the metabolome has proven to be elusive.

Provided herein are systems, devices, and methods for mass spectrometry-based sample testing for untargeted metabolomics analysis. In some embodiments, the systems, devices, and methods can be used for health monitoring. In some embodiments, computational and automation approaches may be used for the mass spectrometry-based metabolomics. In some embodiments, the systems, devices, and methods described herein may be used to explore molecular distributions associated with health and disease. In some embodiments, the methods may be automated to detect molecular panels of interest and detect the full metabolome in a sample simultaneously. For example, the systems, methods and devices may be used to detect metabolomics of bile acids, molecules known to be important for a variety of conditions, and this information can be paired with the rest of the metabolome. In some embodiments, the systems, methods and devices may be used to track diet in relation to exposures, understand environmental risks, and help make educated decisions on lifestyle adjustments. In some embodiments, the systems, methods and devices may be used to track molecular molecules associated with health conditions. In some embodiments, the systems, methods and devices may be used to track molecular data derived from historical samples. In some embodiments, the systems, methods and devices may be used to aid physicians in improved diagnosis and treatment of chronic health conditions.

In some embodiments, the systems, devices and methods include automated sample preparation; data acquisition; quality control (QC) workflows; kit assembly, sample tracking system(s); and/or customer/user interface(s).

The systems, devices, and methods may include high-throughput untargeted mass spectroscopy (MS) based metabolomics for routine monitoring of the chemical composition of a sample, e.g., urine. Traditional mass spectroscopy (MS) based metabolomics has been challenging due to its complexity and was thus confined to large laboratories with advanced capabilities. Currently, the range of MS services that are on the market is limited.

In some embodiments, the untargeted and semi-targeted mass spectroscopy (MS) based metabolomics described herein include: data acquisition techniques that use dataset-wide tandem mass spectroscopy (MS), spectra (MS/MS) collection with increased spectral information while excluding redundant MS/MS spectra and increased throughput; analysis methods and machine learning strategies to analyze metabolomics data at a high volume; robotic sample handling to increase reproducibility and reduce batch effects during sample preparation, and a dried urine sampling (DUS) card as a collection device.

In some embodiments, pre-etched, volumetrically reproducible sampling cards may be used to collect samples from users. In some embodiments, the sampling cards are configured and adapted for self-sampling in a non-clinical setting, enable sample preservation without refrigeration, and/or provide increased reproducibility via interfacing with a robotic sample extraction.

In some embodiments, urine is collected on dry spot cards that are volumetrically controlled. In some embodiments, creatinine normalization can be used to gauge the amount of collected material from the first morning void urine using. Urine is a means by which the kidneys remove many toxins and other chemicals from the blood. The higher concentration of some of these compounds in an individual's urine renders the compounds more readily detectable, especially in a first morning void sample.

In some embodiments, the systems, methods and devices include high-throughput data collection and automatic data processing, analysis, and interpretation functionalities.

In some embodiments, the systems, methods and devices may track molecules and metabolites that are associated with specific health conditions. For example, bile acids that are microbially-produced, pesticides, biocides, antibiotics, environmental toxins, and pathogenic microbial and parasitic metabolites. In some embodiments, a series of panels for these molecules may be established and benchmarked.

In some embodiments, the systems, methods and devices include: collecting samples from volunteers, and identifying the metabolites from the panels of interest that are detectable in urine and cataloguing the metabolites in a reference library.

Samples may be automatically processed for analysis using a robotic system and then analyzed with liquid chromatography mass spectrometry (LC-MS). The detectable molecules in these panels can be included automatically in an user report. The library can be continuously updated to create a comprehensive list of detectable metabolites across a plurality of panels.

The median values for various compounds of interest may be determined which, in conjunction with information from published literature, can be reported to the user as a personalized snapshot of toxin exposure.

In some embodiments, comparisons between volunteers can be determined and specific sources of exposures can be identified. In some embodiments, multiple samples can be acquired. In some embodiments, a rapid LC-MS analysis approach can be used. A sample may be collected at various time intervals, e.g., in 2-5 minute runs.

In some embodiments, a data analysis pipeline can be used to host the data analysis infrastructure. The user report generation tool can be used for identifying and reporting exposures. The tool can be continuously updated to accommodate the volume of data. An interface can be used for receiving samples and tracking of the chain of custody. For example, an user interface for sample submission and instructions to provide relevant information using an online portal (website) may be provided.

In some embodiments, a format for a report regarding a patient may include the presence and level of molecules of interest for a given panel, any relevant user-specific and or sample-specific information, and graphical representation(s) of associated results, for example, ordination plots, comparison to the general population, and possible suggested courses of action.

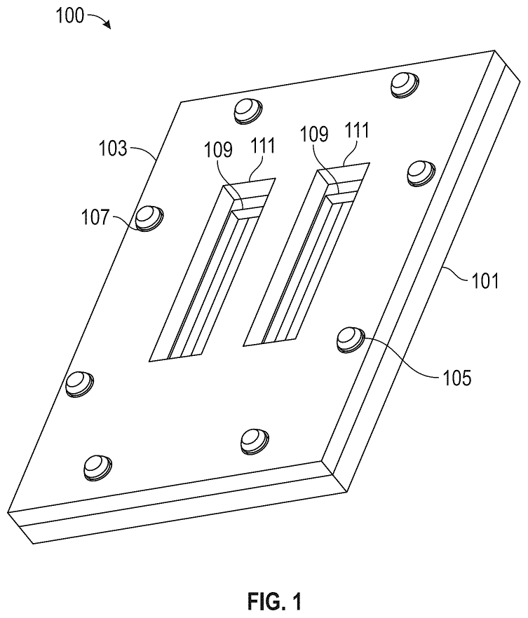

Referring now to FIG. 1, shown is a housing 100 for use with a sample card to collect liquid samples according to some embodiments. The housing 100 may include a first layer 101 and a second layer 103 coupled to each other by one or more corresponding pins 105 extending from the first layer 101 and holes 107 formed in the second layer 103. There may be as many or as few pins 105 and holes 107 as desired to secure the first layer 101 and the second layer 103 together. In some embodiments, the pins 105 have a rounded or chamfered end to facilitate insertion into the corresponding hole 107. In some embodiments, the pins 105 have a flared end that snaps in to place when inserted into the corresponding hole 107 to prevent the first layer 101 and the second layer 103 from being easily separated.

In some embodiments, the location of the pins 105 and the holes 107 may be reversed such that the pins 105 extend from the second layer 103 into holes 107 formed in the first layer 101. In some embodiments, the pins 105 and hole 107 may be replaced or augmented by another means for securing the first layer 101 to the second layer 103, for example, a clasp, a latch, a press fit connection, and/or a screw, although implementations are not limited thereto.

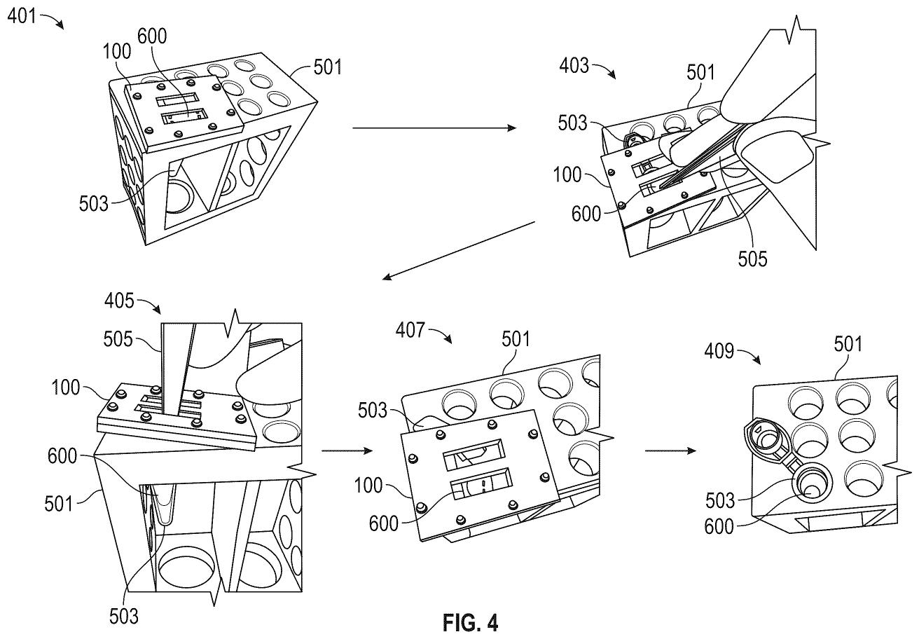

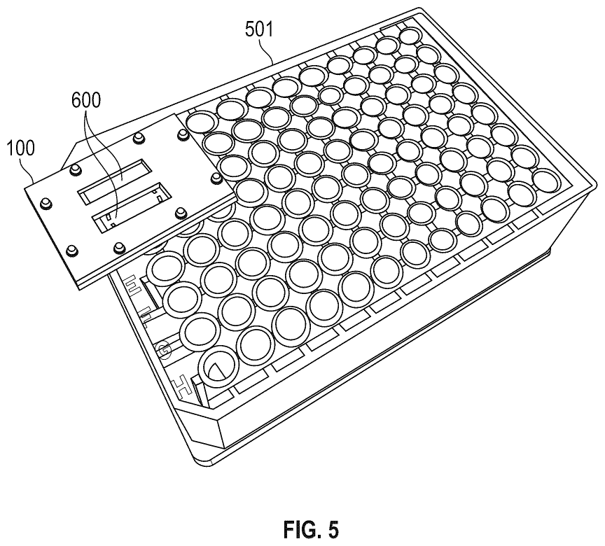

The first layer 101 may have one or more first slots 109 formed therein and the second layer 103 may have one or more corresponding second slots 111 formed therein. The first slots 109 and the second slots 111 may be aligned when the first layer 101 and the second layer 103 are secured together, thereby providing a passage through the housing 100. The slots 109, 111 may be sized and dimensioned to be small enough to secure a sample card therein (shown in FIGS. 4-5) and large enough to enable the sample card to be extracted from the housing 100 through one of the slots 109, 111. In some embodiments, the first layer 101 and the second layer 103 are permanently secured together and the first slots 109 and the second slots 111 provide ingress and egress into the interior of the housing 100. In some embodiments, the first layer 101 and the second layer 103 are removably/detachably coupled to each other and can be freely opened and closed as desired.

In some embodiments, the first layer 101 may be made from a hydrophobic material, for example polypropylene (PP). Polypropylene is a thermoplastic polymer known for its high chemical resistance, durability, and low moisture absorption. These properties make it an ideal material for manufacturing medical and laboratory equipment such as syringes, test tubes, and containers. Polypropylene is also autoclavable, meaning it can withstand the high temperatures and pressures of sterilization processes without degrading. In some embodiments, similar materials that may be used in place of polypropylene for medical sample containers, including polyethylene (PE), polycarbonate (PC), polystyrene (PS), and polyvinyl chloride (PVC). Each of these materials offers various degrees of chemical resistance, durability, and suitability for sterilization, making them viable alternatives depending on the specific application requirements. In some embodiments, the first layer 101 may contain at least one of polypropylene, polyethylene, polycarbonate, polystyrene, polyvinyl chloride, or another similar materials, alone or in combination.

In some embodiments, the second layer 103 may be made from a hydrophilic material, for example polylactic acid (PLA). Polylactic acid is a biodegradable and bioactive thermoplastic derived from renewable resources like corn starch or sugarcane. Polylactic acid exhibits excellent biocompatibility and is characterized by its transparency, rigidity, and high tensile strength. In medical and laboratory settings, Polylactic acid is used to manufacture medical sample containers, surgical sutures, and drug delivery systems due to its ability to safely degrade within the body. In some embodiments, similar materials that may be used in place of polylactic acid, including polyhydroxyalkanoates (PHA), polycaprolactone (PCL), polyglycolic acid (PGA), polyethylene glycol (PEG), and polydioxanone (PDO). In some embodiments, the second layer 103 may contain at least one of polylactic acid, Polyhydroxyalkanoates, Polycaprolactone Polyglycolic acid, Polyethylene glycol, Polydioxanone, or another similar material, alone or in combination.

In embodiments, the hydrophobic layer prevents pooling of the liquid sample that is being absorbed by the sample card in the housing 100 and directs flow towards the edges. In some embodiments, the hydrophilic layer may absorb excess liquid sample to facilitate drying the sample. Selection of hydrophobic and hydrophilic material(s) and/or coating(s) may be based on specific conditions and requirements, allowing for customization to suit different diagnostic needs and environments.

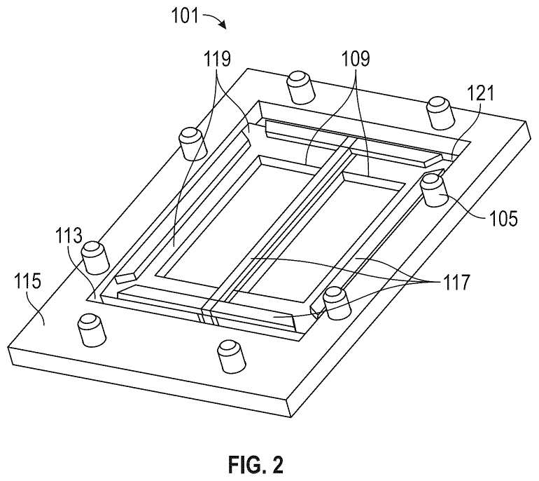

Referring now to FIG. 2, shown is the first layer 101 of housing 100 according to embodiments. The first layer 101 has a sub-frame 113 which is set back from an interior face 115 of the first layer 101. The sub-frame 113 has a plurality of fixtures 117 formed thereon or associated therewith. Fixtures 117 define an intermediary surface between the interior face 115 of the first layer 101 and the sub-frame 113. The sample card (shown in FIGS. 4-5) may be positioned in the intermediary region, above the sub-frame 113 and below the second layer 103. In some embodiments, the sample card is pressed into the fixtures 117 by the second layer 103 when the second layer 103 is secured to the first layer 101.

The fixtures 117 may define a series of channels 119 along the surface of the sub-frame 113. Channels 119 may direct flow of the liquid sample to the edges of the sub-frame 113 and the sample card and into an overflow slot 121. In some embodiments, the overflow slot 121 is an elongated gutter along an edge of the sub-frame 113. In some embodiments, the overflow slot 121 may be a series of holes, slits, perforations, and/or other openings that allow excess liquid sample to flow out of housing 100. In some embodiments, all or part of the first layer 101 may be made of a hydrophobic material to prevent liquid from pooling on the sub-frame 113 or in the channels 119. The hydrophobic material may also promote flow of the liquid sample along the channels 119 and into the overflow slot 121.

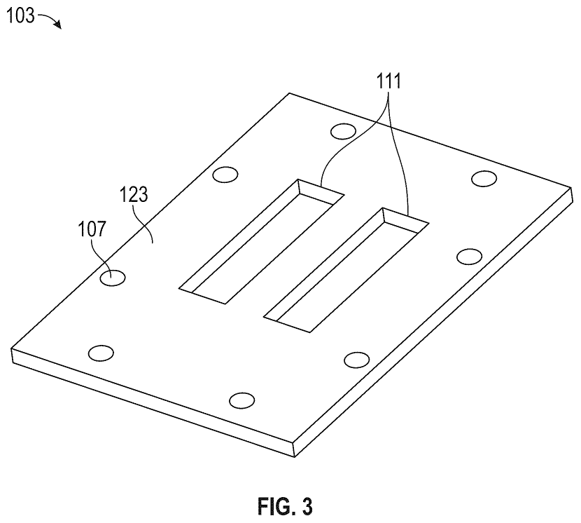

Referring now to FIG. 3, an embodiment of second layer 103 of housing 100 is shown. The second layer 103 may have an interior face 123 which is flat or substantially flat. In this way, when the sample card is between the first layer 101 and the second layer 103, the sample card is in contact with a greater surface area of the interior face 123 of the second layer 103 as compared to the surface area of the fixtures 117. In some embodiments, when the second layer 103 is fabricated, in whole or in part, from a hydrophilic material, the interior face 123 of the second layer 103 absorbs excess liquid sample from the sample card and promotes drying of the liquid sample and sample card.

Referring now to FIG. 4, shown is a process flow for preparing a sample for testing according to embodiments. In step 401, the housing 100, with the sample card 600 positioned therein, is placed on a test tube plate 501 over a test tube 503. The housing 100 is positioned such that the sample card 600 and at least one of the slots 109, 111 is aligned over an open end of the test tube 503. The sample card 600 may include a dried sample absorbed therein. In step 403, the sample card 600 is extracted using a pair of forceps 505. The forceps 505 may be used to push or pull the sample card 600 from inside the housing 100 into the test tube 503.

In some embodiments, the forceps 505 may be disposable forceps for use with a particular sample or sample card 600. The forceps 505 may be made of the same material as the first layer 101, the second layer 103, or a different material, for example metal. In some embodiments, the forceps 505 may be a part of a sample collection kit for use with the housing 100 and sample card 600. In some embodiments, the forceps 505 may be reusable.

In step 405, the sample card 600 further extracted from the housing 100 with the sample card 600 partially positioned in the test tube 503. In some embodiments, the slots 109, 111 and the forceps 505 may be sized and dimensioned to allow the forceps 505 to pass through both slots 109, 111 to facilitate extraction. In step 407, the sample card 600 is fully removed from the housing 100 and is placed inside the test tube 503. In step 409, the now empty housing 100 is removed, leaving the test tube 503 with the sample card 600 inside ready for analysis.

Referring now to FIG. 5, shown is housing 100 holding one or more sample cards 600 on a test tube plate 501 according to embodiments. In some embodiments, the housing 100 may hold more than one sample card 600, for example, two sample cards 600. Both sample cards 600 may be positioned side-by-side or partially or wholly overlapping each other between the first layer 101 and the second layer 103. In some embodiments, one of the sample cards 600 may be used for analysis and the other sample card 600 may be kept for long term storage. In some embodiments, the one or more sample cards 600 may be the same and shape, retaining an equal amount of the liquid sample, or may be a different size and shape, retaining a different amount of the liquid sample, as another sample card 600 of the one or more sample cards 600. In some embodiments, the sample card 600 may be separable into discrete subsections, with each subsection being separately removable from the housing 100.

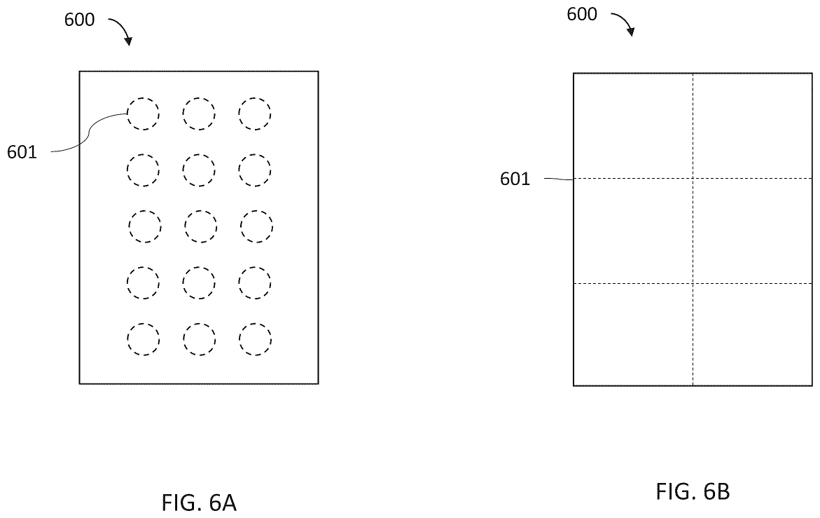

Referring now to FIGS. 6A and 6B, shown is the sample card 600 according to embodiments. The sample card 600 may be made of any absorbent material suitable for absorbing and retaining the desired liquid sample. For example, when urine is the liquid sample, the sample card 600 may be made, in whole or in part, of cellulose or a synthetic alternative to cellulose. It is appreciated that the cellulose used to make the sample card 600 may be wood pulp, straw, cotton, another plant fiber, or recycled paper, although not limited thereto.

In some embodiments, the sample card 600 may be sized, shaped, and dimensioned based on the material of the sample card 600 and the target liquid sample, to absorb a predetermined amount of the liquid sample. By retaining a known amount of liquid sample, the sample card 600 may be used for quantitative analysis. For example, in some embodiments the sample card 600 may absorb 50 microliters to 100 microliters of the liquid sample. In some embodiments, the sample card 600 may absorb 70 microliters to 80 microliters of the liquid sample. In some embodiments, the sample card 600 may absorb 75 microliters of the liquid sample. It is appreciated that the sample card 600 may be configured, i.e., by modifying the size, shape, and/or material, as desired to absorb specific amounts or ranges of liquid sample.

In some embodiments, the sample card 600 may absorb the liquid sample in a uniform manner such that a subsection of the sample card 600 retains a known amount of liquid sample based on the size, shape and material of the sample card 600. In some embodiments, the sample card 600 has marking(s) 601. The marking(s) 601 may take the form of a depression, crease, line, perforation, or other visual or tactile feature for indicating a subsection of the sample card 600. In some embodiments, the markings 601 may facilitate removal of the subsection from the sample card 600, for example, pre-cut or perforated edges. The marking(s) 601 may further define a subsection with a known amount of the liquid sample.

In some embodiments, the marking(s) 601 define uniform subsections, with each subsection being the same size and shape and therefore retaining an equal amount of the liquid sample. In some embodiments, the marking(s) 601 define non-uniform subsection, with at least one of the subsection being a different size or shape that the other subsections. In such embodiments, the non-uniform subsection may retain the same or a different predetermined amount of the liquid sample. For example, the non-uniform sections may have different sizes and shapes, but an equal area/volume retaining an equal amount of the liquid sample or an unequal area/volume retaining a different predetermined amount of liquid sample. In some embodiments, different sized or shaped subsection may be adapted for use in different mass spectrometers. In this way a single sample card 600 may be used to accommodate various tests in different mass spectrometers.

For example, in an embodiment illustrated in FIG. 6A, the markings 601 form a plurality of circular subsections on the sample card 600. The circular subsections may retain a predetermined amount of liquid sample, for example 3 microliters to 7 microliters (e.g., 5 microliters). In an embodiment illustrated in FIG. 6B, the markings 601 subdivide the sample card into six subsections. In some embodiments, the subsections may be equal in size. In this way, a single sample card 600 collected from a user may be subdivided to provide samples for multiple different tests as desired depending on the amount of sample to be analyzed. For example, multiple iterations of the same test may be supported, or different tests may be supported which, based on the target metric to be analyzed, may require more (or less) of the sample to be tested.

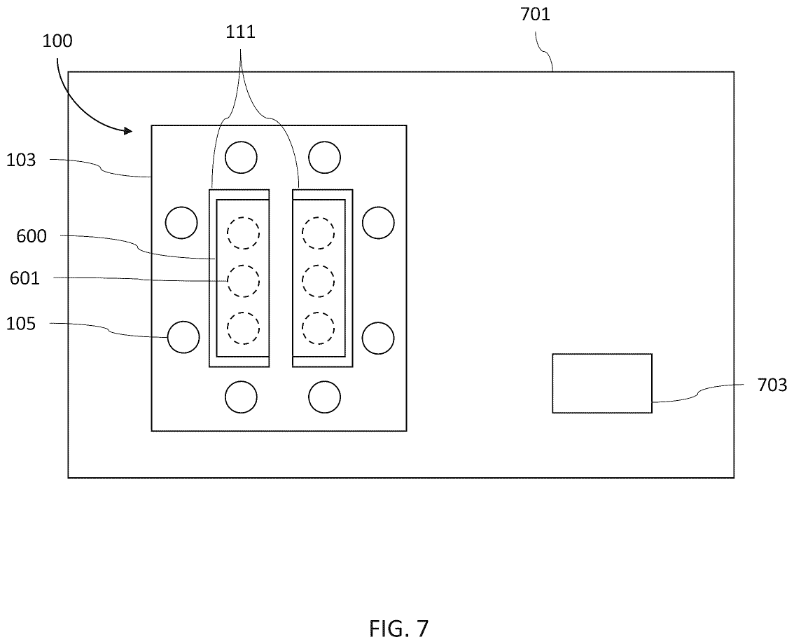

Referring now to FIG. 7, shown is a transport container 701 for a housing 100 and sample card 600 according to embodiments. In some embodiments, the sample card 600 may be transported to an appropriate testing facility, for example, the sample card may be prepared by a user at home or may need to be transferred from a clinic to a facility with more advanced testing capabilities. In such instances, the system may include a container 701 for transporting the housing 100 and sample card 600. The container 701 may be a resealable plastic bag or other sealable container which prevents contamination of the sample card 600. A desiccant 703, for example, silica gel, may be included in the container 701 with the housing 100 and the sample card 600 to maintain a dry environment to prevent rehydration of the dried sample stored in the sample card 600. In some embodiments, the container 701 with the desiccant 703, housing 100, and sample card 600 may be suitable for transport via mail using standard postal services.

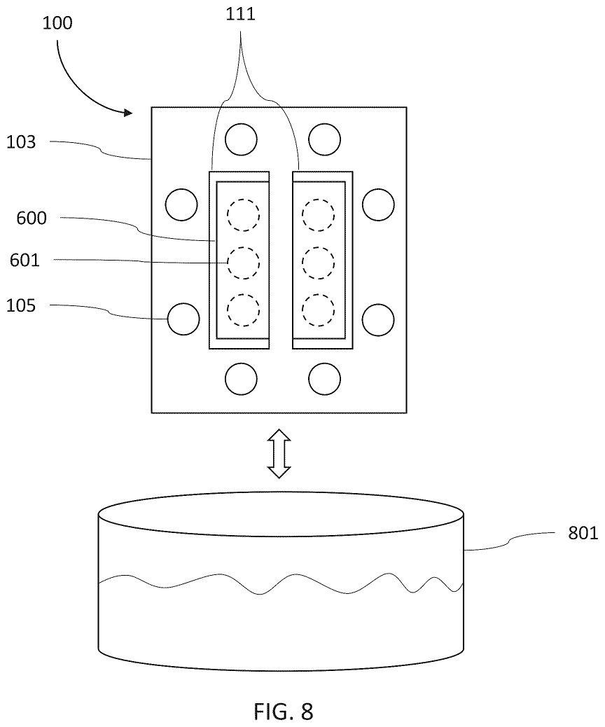

Referring now to FIG. 8, shown is sample card 600 in a housing 100 being used as a sub-sampling device according to embodiments. In some embodiments, the sample card 600 may be used as a sub-sampling device for use with a sample cup 801. For example, a liquid sample, e.g., urine, may be collected from a user in the sample cup 801 and the housing 100 and sample card 600 may then be wholly or partially submerged in the sample cup 801, the liquid sample passing through the slots 109, 111. The sample card 600 may then be dried and sent to a laboratory. In this way, a single sample may be collected from a user and used for analysis, for example, locally at a clinic, and may be further prepared and sent to another facility for additional analysis. In some embodiments, the liquid sample may be collected directly on the sample card 600.

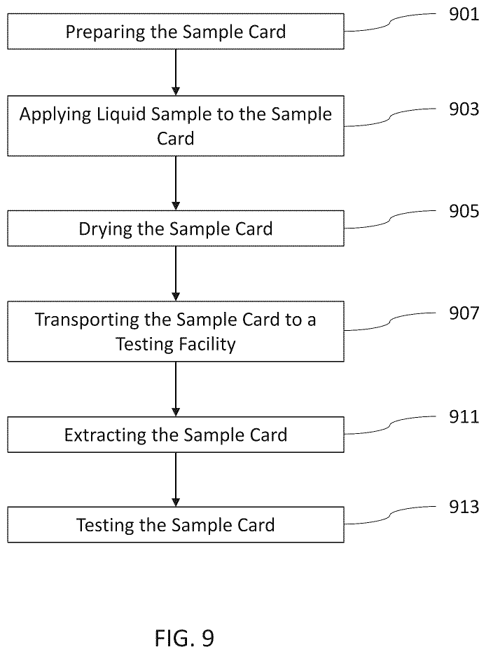

Referring now to FIG. 9, shown is a process flow for sample collection and preparation according to embodiments. In step 901, the sample card 600 is prepared. In some embodiments, preparing the sample card 600 may include placing the sample card 600 between the first layer 101 and the second layer 103 of the housing 100 and snapping the housing 100 closed. In step 903, the liquid sample is applied to the sample card 600. In some embodiments, the liquid sample is applied directly to the sample card 600 or the sample card 600 is used as a sub-sampling device with a pre-collected sample. Forceps 505 may be used to handle the housing 100 and sample card 600 to prevent contamination. In step 905, the sample card 600 saturated with the liquid sample is dried. In some embodiments, the hydrophilic material of the second layer 103 and the channels 119 facilitate drying of the sample card 600. In some embodiments, the sample card 600 is left out in the open, i.e., in ambient conditions, to air dry. In some embodiments, a heat lamp or other drying accelerant may be used to reduce the time needed for the sample card 600 to dry.

Once the sample card 600 is dry, in step 907, the sample card 600 is transported to a testing facility. In some embodiments, the card 600 may be transported from a clinic where the sample was taken to a back room where testing will be performed. In some embodiments, the sample card 600 will be packaged in a container 701 with a desiccant 703 and transported to a lab for testing. In some embodiments, the sample card 600 is prepared by a user at home and sent via standard postal services (or other delivery service) to a lab for testing. In step 911, the sample card 600 may then be extracted from the housing 100. In some embodiments, a subsection of the sample card 600 is extracted for testing based on the amount of the sample in the subsection and the desired amount of sample for desired testing. In step 913, the sample card 600, or a subsection thereof, is tested, for example using mass spectrometry for metabolite analysis.

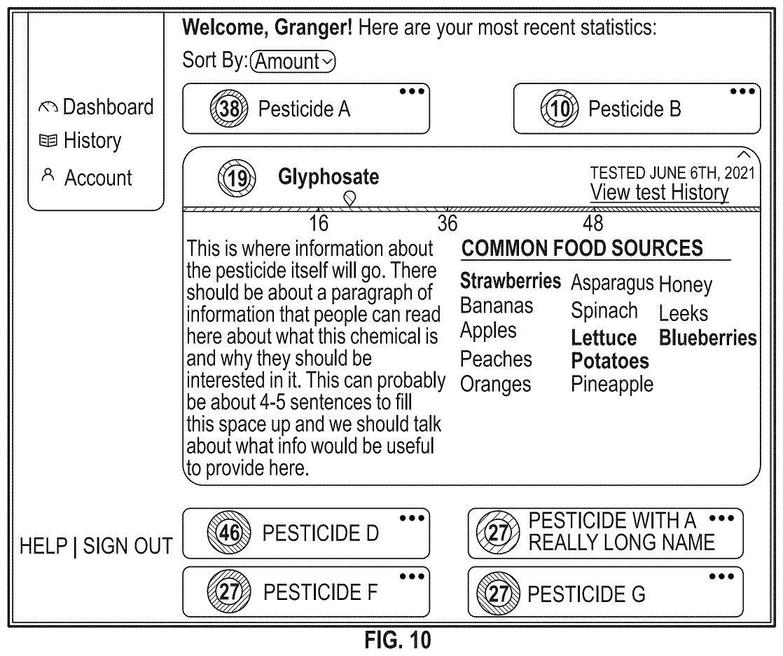

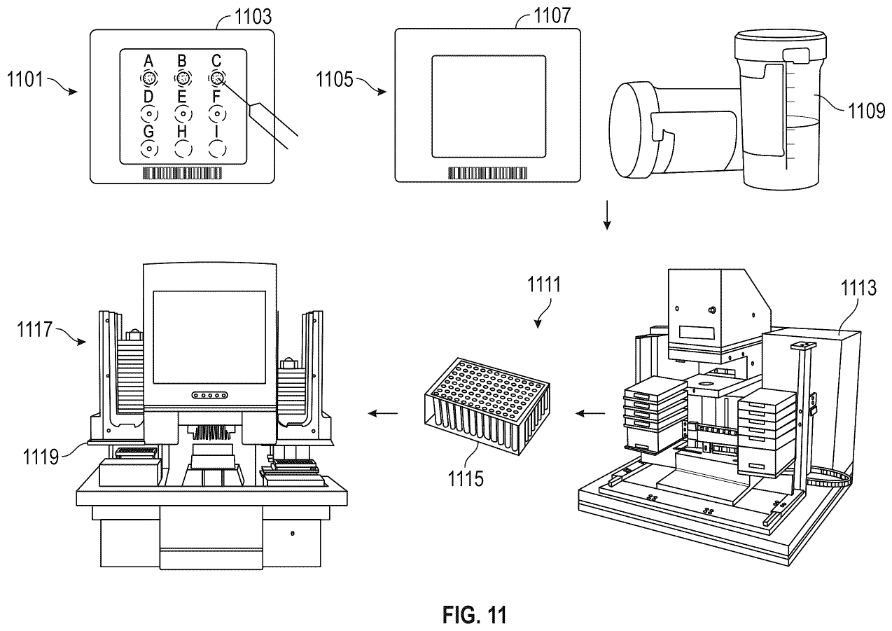

Referring now to FIG. 10, shown is a graphic depicting an example of a patient or healthcare provider interface according to embodiments. In embodiments, an user report is generated that includes information about detected metabolites. In embodiments, the metabolites of interest are pesticides. In addition to presenting sample data, the system may collect relevant data from a chemical library. The relevant data may include demographic information related to the metabolites, or other chemicals. Examples of demographic information include comparative data, localities where the metabolites (pesticides) are more prevalent and the like. Chemically specific data may be included as well. For example, common sources of the metabolites, any known risks or benefits associated with the metabolites, interactions and other such information may be included. In some embodiments, the interface can recommend the user to seek a doctor's advice before taking any actions on their health.

Systems, methods and devices may include: a set of workflows for several panels of molecules with health implications (e.g., bile acids) with protocols for each step of the process, such as sampled DUS card intake, sample preparation and analysis, and data processing and analysis; a sampling kit, sample chain of custody tracking, and generation of a report that conveys scientific information to a user-friendly set of bullet points of importance and interest; and protocols such as MS analysis protocols and data processing capabilities.

Urine is easy to collect and contains a variety of endogenous and exogenously-derived molecules (and their metabolites) associated with the environment. Information on these molecules can provide a snapshot regarding the health, diet, exposures, and other such considerations for an individual. However, despite the case of urine collection in the form of liquid, handling of urine can be challenging. For example, transportation of liquid is challenging and costly, as it requires appropriate handling. Additionally, many molecules are less stable in liquid state than in the dried state and thus refrigeration is needed. Further, a dried sample is more concentrated and therefore increases the sensitivity of compound detection in the matrix, which can improve non-targeted (i.e. detecting all molecules) measurements.

Sampling urine using a dried method has been validated for several analytes including, for example, iodine (in the iodine deficiency assays) and creatinine with comparable results to the standard liquid collection method. The dried urine on paper method has also been used to analyze hormones in multiple studies.

Referring now to FIG. 11, aspects of a workflow are depicted. In the workflow, a device 1101 is configured for blood sampling (DBS) 1103; 1105 depicts a similar device for dried urine sampling (DUS) 1107 alongside a typical wide mouth container 1109 used for collection; 1111 is an illustration of an automatic DUS punching robot 1113 that is capable of processing DUS cards to fill two 96-deep well plates 1115; 1117 is an illustration of an associated sample preparation robot 1119 for preparation of the numerous samples generated by the punching robot 1113.

Examples of devices that may be adapted and made suitable for use with the systems, methods and devices include devices available from TOMTEC of Hamden Connecticut. Included are the DUS card, the Auto DBS-4 device, and a liquid handling device, such as the Quadra 4. Generally, while these devices are adapted for dried blood spots, one skilled in the art can readily make adaptations or adjustments for dried urine.

For example, with regards to sampling, a wide mouth container 1109 that accommodates a DUS card 1107 can be used to collect the morning (mid-stream) urine sample. In some embodiments, the DBS card 1103 may be designed to retain a predetermined amount of liquid (e.g., 12 uL for blood) within a pre-etched region and can be modified to collect about 200 uL of urine on the DUS card 1107. In some embodiments, the DBS card 1103 may be designed without a pre-etched region to retain a predetermined amount of liquid (e.g., 12 uL for blood) in the entire card. Each card 1103, 1107 can be barcoded for sample tracking and processing purposes. The card 1103, 1107 can then be dried on the collection container and placed in a lockable plastic bag containing a desiccant for shipping, collection, and further processing. An automatic DBS/DUS punching robot 1113 (e.g., TomTec Automatic DUS punching robot) can be used to collect 10 punch outs (representing about 120 uL urine) from the developed DUS cards 1107, into a deep 96-well plate 1115 and further processed using any suitable preparation apparatus. (e.g., TomTec Quadra 4 sample preparation robot). The preparation apparatus can be used for sample resolubilization, QA/QC procedures (e.g. internal standard spike, pooled QC sample assembly, and dilutions) and solid phase extraction procedures.

In short, the sample collection and handling protocols described herein may be used in high-throughput processing. A number of mass spectrometers that may be suited for use with the teachings herein include those available from Thermo Fisher Scientific of Waltham Massachusetts. For example, the Orbitrap Exploris™ 480 Mass Spectrometer.

In some embodiments, high-throughput MS-based metabolomics can be used for monitoring of urine chemical composition. Untargeted MS can reveal complex chemistries, including such extremely complex systems as host-microbiome interactions and can have higher potential diagnostic accuracy than relying on the measurement of only one or a few individual biomarkers.

In some embodiments, data-dependent acquisition (DDA) can be used for untargeted data acquisition using tandem MS. The DDA method allows the collection of 5-10 fragmentation spectra (MS/MS) of the most abundant peaks per each parent spectrum during sample analysis.

In some embodiments, a variation of DDA, such as dataset-dependent acquisition (DSDA) approach can be used for untargeted data acquisition using tandem MS. For example, using DSDA, every time a good quality fragmentation spectra is collected in one sample, it can be remembered and included in the exclusion list, so the next time the peak appears during the sequence of the analyzed samples, it will not be considered for fragmentation analysis. This process can gradually exhausts the collection of major/abundant peaks that are usually present in all samples of the same type and focuses on collection of the minor components of each sample. To increase the efficiency of exclusion, a pooled quality check (PQC) sample can be prepared by mixing each sample in the processing batch. PQC can be injected several times in the beginning of the analysis sequence and throughout the sequence to quickly analyze the most abundant peaks to create an exhaustive exclusion list. This approach can generate a dataset of all sufficiently abundant compounds with fragmentation patterns for further identification and analysis.

This approach can allow collection many data points for non-targeted data acquisition and can be used for large-scale analyses.

Untargeted datasets can contain thousands to millions of features (individual spectra for detected molecules). Advanced computational approaches can be used for large-scale data processing and analysis.

Any suitable tool for extraction and deconvolution of individual peaks/features for molecules detected by the mass spectrometer can be used (e.g., the MSHub for gas chromatography MS (GC-MS) datasets, MZMine2 software package). MSHub uses an AI-driven approach to automatically optimize data processing parameters and can be scalable to process an unlimited number of samples. MSHub can be adapted for liquid chromatography MS (LC-MS).

“Metabolomic dark matter” comprises the molecules that are detectable but not identifiable during annotation vial library matching. For example, 2-10% of molecules are identifiable and thus at least 90% are “dark matter”.

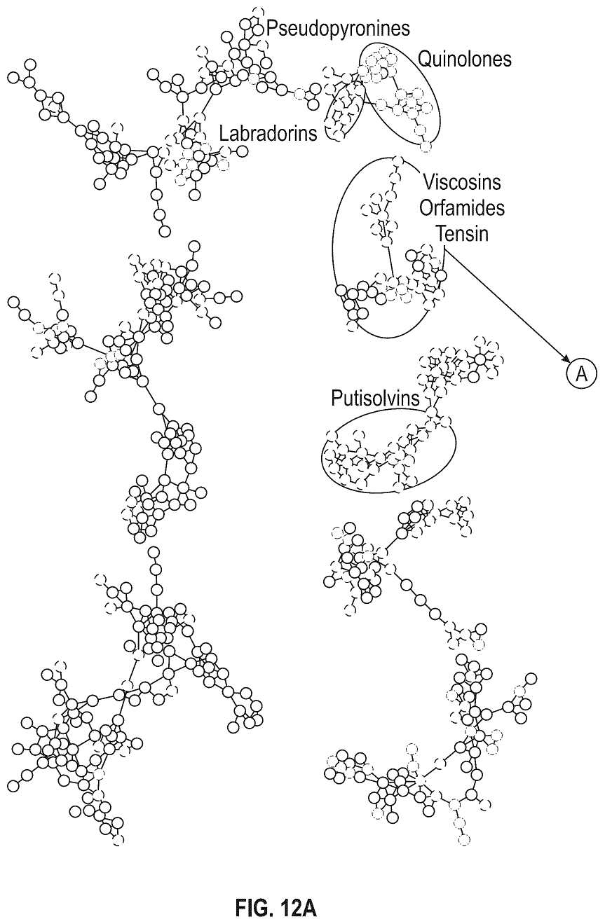

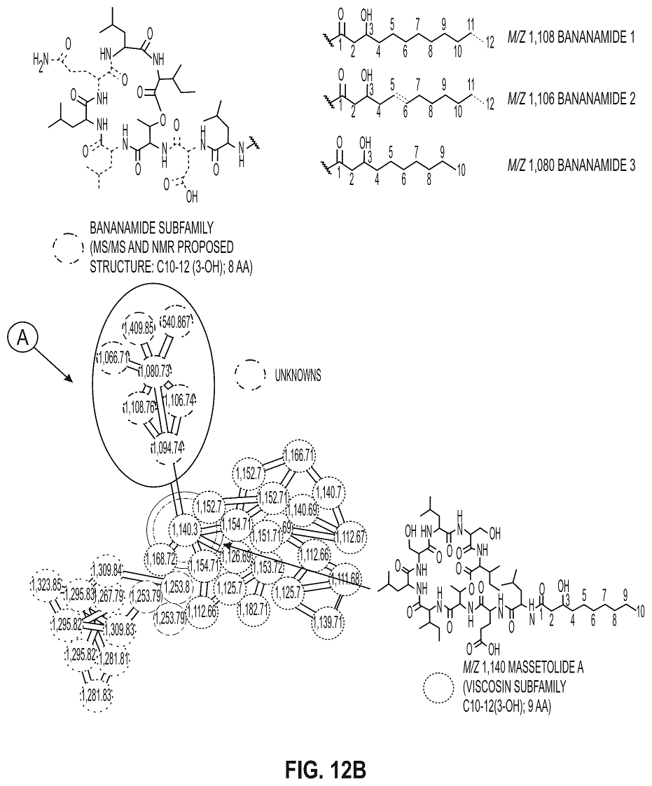

Referring now to FIGS. 12A-B, any suitable tool can be used to identify and visualize “metabolomic dark matter” (e.g., Molecular Networking (MN)). MN allows filtering and organizing large non-targeted dataset into clusters of structurally related molecular families. Organizing data in such a manner allows for quick annotation of known molecules and discovery of previously unknown molecules using an annotation propagation strategy.

In FIGS. 12A-B, exemplary aspects of molecular networking are depicted. Under heading A aspects of partial molecular network from of LC-MS/MS data from bacterial extracts are depicted. Under heading B, discovery of novel molecules is depicted. In this example, lipopeptide biosurfactants are compared using Molecular Networking annotation propagation.

A metadata collection protocol via an online platform (e.g., website, smartphone application) can be used, wherein the customer can be guided through a set of questions and sampling routines. For example, questions covering environmental factors, diet, and exposures can be asked.

Any suitable protocols developed for online platform can be adapted for metadata collection protocol (e.g., American Gut Project). Study participants can have the ability to log their food during the study. Collected anonymized metadata can be associated with a sampling card(s) barcodes and stored on any suitable platform (e.g., DNAnexus, which is a HIPAA compliant cloud-based data analytics and storage platform).

After the data is processed, machine learning strategies can be used to analyze the data and extract the hidden molecular messages contained in the sample, such as the distortion of expected bile acid distribution profile, presence of unexpected, especially microbially-produced bile acids, and any other notable findings. Non-limiting examples include presence of toxin or drug metabolites (including untargeted molecules), notable molecular trends sample-to-sample (if multiple samples have been submitted), or changes in molecular profile(s) associated with an event (given a sufficient number of samples pre- and post-event).

In some embodiments, molecules and their metabolites that have known health associations (e.g., bile acids, steroids, carnitines) or pose known health risks, such as pesticides and other biocides, antibiotics, environmental toxins, and pathogenic microbial/parasitic metabolites can be analyzed.

In some embodiments, the database of the molecules and their metabolites described herein can serve as a research-grade tool for identifying exposures. The tool can be continuously updated as the volume of data increases.

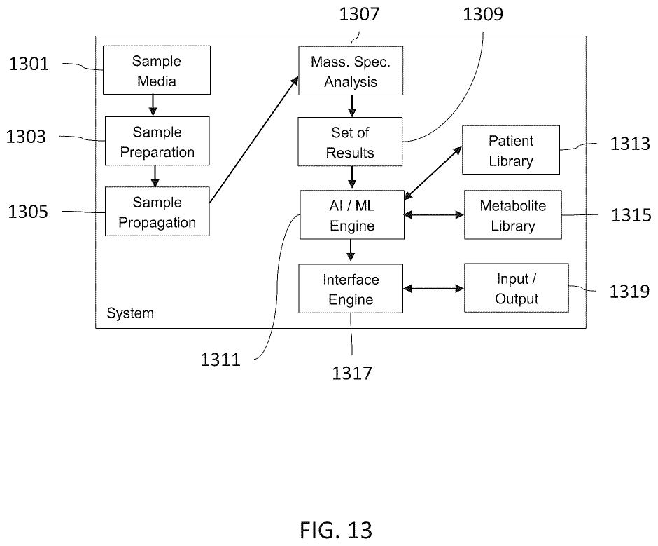

Referring now to FIG. 13, a non-limiting example of a system for implementing the teachings herein is shown. In step 1301, the system begins with the collection of a sample in sample media. In step 1303, the sample media may be prepared, for example, by drying. In step 1305, sample propagation may include reduction or segmentation of the prepared sample. Once the sample has been suitably prepared for analysis, in step 1307, the sample may be put into a mass spectroscopy system for mass spectroscopy analysis. Mass spectroscopy analysis may involve one to many analysis sequences. Collectively, in step 1309, the analysis sequences provides for a set of results. In step 1311, the set of results is reviewed and interpreted by use of artificial intelligence. For example, the system may be established in make use of the machine learning. In order to complete analysis of the set of results, the AI engine will refer to and update a metabolite library 1315 and a patient library 1313. Generally, the metabolite library 1315 contains an abundance of data related to metabolites. Generally, the patient library 1313 contains patient oriented data including medical profile, history, medications and the like. The AI engine is interfaced by a user through an interface engine 1317. The interface engine 1317 may provide or receive data through input/output 1319. In some embodiments the data may be displayed using an interface similar to the interface discussed with respect to FIG. 10. In some instances, the interface engine 1317 may be used for editing library data 1313, 1315. The AI engine may include functionality for modeling unknown molecules, similar to modeling unknown molecules as discussed with reference to FIGS. 12A-B. Output may report identification of such molecules and flag them for further analysis.

In some embodiments, the system for urine-based untargeted metabolomics described herein includes: automated sample preparation and data acquisition workflow based on the validated urine volume controlled dry spot cards using healthy urine. The workflow may include (i) extraction of DUS, (ii) QA/QC, (iii) DSDA acquisition using LC-MS/MS, and (iv) data processing pipeline developments; reference data accumulation including (i) gathering existing reference spectra from commercial and open sources (e.g. GNPS spectral libraries (link)) and (ii) assembly of designated libraries, sample tracking system and an interface for customers to enable metadata collection, and a kit assembly.

Where functionality disclosed herein may be implemented by a computer, the functionality may be provided as machine executable instructions stored on non-transitory, machine readable media. Generally, the functionality may include aspects of artificial intelligence (AI) and/or machine learning (ML). Generally, AI encompasses a broad spectrum of technologies aimed at simulating human intelligence, while ML is a subset of AI focused on developing algorithms that allow computers to learn from data. Examples of ML that may be suited for practice of the teachings herein include: supervised learning, unsupervised learning, reinforcement learning, semi-supervised learning and deep learning.

Generally, supervised learning involves training a model on labeled data, where the algorithm learns to make predictions based on input-output pairs. Generally, unsupervised learning involves training a model on unlabeled data, where the algorithm learns to identify patterns and structures within the data without explicit guidance. Clustering and dimensionality reduction are typical unsupervised learning techniques. Generally, reinforcement learning involves training an agent to interact with an environment in order to achieve a specific goal. The agent learns through trial and error, receiving feedback in the form of rewards or penalties based on its actions. Generally, semi-supervised learning combines elements of both supervised and unsupervised learning, leveraging a small amount of labeled data along with a larger pool of unlabeled data to improve model performance. Generally, deep learning is a subset of ML that uses artificial neural networks with multiple layers (deep neural networks) to extract high-level features from raw data.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

What is claimed is:

1. A liquid sample collection system comprising:
a housing that includes a first layer and a second layer coupled to the first layer;
one or more channels integrated into the first layer from an interior region of the first layer to an edge of the first layer; and
a card secured between the first layer and the second layer;
wherein the first layer is made, in whole or in part, from a hydrophobic polymer and the second layer is made, in whole or in part, from a hydrophilic polymer;
wherein the one or more channels distribute a liquid sample over the card.

2. The system of claim 1, wherein the first layer is made at least in part from one or more of polypropylene (PP), polyethylene (PE), polycarbonate (PC), polystyrene (PS), and polyvinyl chloride (PVC).

3. The system of claim 1, wherein the second layer is made at least in part from one or more of polylactic acid (PLA), polyhydroxyalkanoates (PHA), polycaprolactone (PCL), polyglycolic acid (PGA), polyethylene glycol (PEG), and polydioxanone (PDO).

4. The system of claim 1, wherein the one or more channels are tapered, being wider nearer the central region of the first layer and narrower near the edge of the first layer.

5. The system of claim 1, wherein the liquid sample is applied directly to the first layer, the second layer, and the card.

6. The system of claim 1, wherein the housing and the card are used to collect a subsample of the liquid sample.

7. The system of claim 1, wherein the card is sized and dimensioned to retain a predetermined amount of the liquid sample.

8. The system of claim 7, wherein the card is adapted for use in a mass spectrometer configured for developing metabolomics data from the liquid sample.

9. The system of claim 1, wherein the housing has at least one slot formed therethrough.

10. The system of claim 9, wherein the card is removable through the at least one slot.

11. The system of claim 1, wherein the card is dividable into a plurality of subsections, each of the subsections retaining a predetermined amount of the liquid sample.

12. The system of claim 11, wherein the card has perforations between each of the subsections.

13. The system of claim 11, wherein the subsections of the plurality of subsections are uniform and retain an equal amount of the liquid sample.

14. The system of claim 11, wherein the subsections of the plurality of subsections are non-uniform and at least one of the subsections retains a different amount of the liquid sample.

15. A liquid sample preparation system comprising:
a collection card comprising:
a first layer having a first slot;
a second layer having a second slot, the second layer being coupled to the first layer with the second slot aligned with the first slot;
one or more channels integrated into the first layer from a central region of the first layer to an edge of the first layer; and
an insert removably secured between the first layer and the second layer, the insert being configured to retain a predetermined amount of the liquid sample;
wherein the first layer is made, at least in part, from a hydrophobic polymer and the second layer is made, at least in part, from a hydrophilic polymer;
wherein the one or more channels distribute the liquid sample across the insert;
wherein the insert is removable through the first slot or the second slot;
a container;
a desiccant; and
a pair of forceps for use in manipulating the collection card;
wherein the desiccant and the collection card are adapted to be stored in the container for transport.

16. The system of claim 15, wherein the insert is adapted for use in a mass spectrometer configured for developing metabolomics data from the liquid sample.

17. The system of claim 15, wherein the insert is dividable into a plurality of subsections, each of the subsections being adapted for use in a mass spectrometer configured for developing metabolomics data from the liquid sample.

18. A liquid sample collection system for mass spectrometry analysis, comprising:
a housing having a first layer and a second layer coupled to the first layer;
one or more channels integrated into the first layer from an interior region of the first layer to an edge of the first layer; and
a card secured between the first layer and the second layer;
wherein the first layer is made, in whole or in part, from a hydrophobic polymer and the second layer is made, in whole or in part, from a hydrophilic polymer;
wherein the one or more channels distribute the liquid sample over the card;
wherein the card is configured to retain a predetermined amount of the liquid sample and is adapted for use in a mass spectrometer configured for developing metabolomics data from the liquid sample.

19. The system of claim 18, wherein the liquid sample is urine and the card is a dried urine sampling (DUS).

20. The system of claim 18, wherein the liquid sample is blood and the card is a dried blood sampling (DBS).
